(19) United States
(12) Patent Application Publication
(10) Pub. No.: US 2006/0080500 A1
(43) Pub. Date: Apr. 13, 2006

(54) Method and system for managing data transfer between different types of tape media

(75) Inventors: Jenny Faith Manthey, Coatesville, PA (US); David Gerald Lake, Douglassville, PA (US); William W. Disney, Downingtown, PA (US)

Correspondence Address: UNISYS CORPORATION, UNISYS WAY, MAILSTOP E8-114, BLUE BELL, PA, 19424-0001, US

(73) Assignee: Unisys Corporation, Blue Bell, PA (US)

(21) Appl. No.: 10/961,504

(22) Filed: Oct. 7, 2004

(51) Int. Cl. G06F 12/00

(52) U.S. Cl. 711/111; 711/165

(57) ABSTRACT

A method and system for managing the transfer of data from one tape to another. The system uses an operating system to control a plurality of tape drives and a tape manager. The system is configured to enable a user to create a stacked tape, unstack a previously stacked tape, and/or consolidate a previously stacked tape. When a stack is created, data is copied from one or more input tapes to an output tape in any desired format using American National Standards Institute (ANSI) standard labeling conventions. When a user requests that data be unstacked, virtual tape volume (VTVs) on one or more input tapes are located and copied to respective opened output tapes. When data is consolidated, VTVs on one or more input tapes are copied to a single output tape. When data consolidation or stack creation is complete, a directory is written to the output tape.

### FIELD OF INVENTION

The present invention relates to managing data transfer between different types of tape media. More specifically, the present invention relates to back-up tape media migration and consolidation between heterogeneous tape formats.

### BACKGROUND

Tape drives and media for backing-up data are enhanced over time with newer tape drives and media providing various benefits over older ones. As newer tape drives and media become more mature and gain market share, older tape drives and media are often phased out and become unavailable. For example, the sole remaining supplier of the so-called 36-track tape drive recently announced that such drives will no longer be manufactured and that support is being discontinued.

Tape drives such as the 36-track tape are typically supported for as long as the spare parts supply lasts. After that, users of obsolete tape drives having data stored on tapes associated with an obsolete tape drive have no way of accessing that data. Referring now to FIG. 1, there is shown a conventional computer system 100 including a computer 102, such as a server for example, an old tape drive 104, and a new tape drive 106. In the prior art, users who have upgraded to a new tape drive 106 typically keep their old tape drive 104 on-line so that data written to tapes associated with the old tape drive 104 may be restored, if needed. However, this data may become inaccessible where the old tape drive 104 fails and the necessary parts for repairing the old tape drive are not available.

A need therefore exists for a method and system for managing data transfer between different types of tape drives and media.

### SUMMARY

The present invention is related to a method and system for managing the transfer of data from one tape to another. The system uses an operating system to control a plurality of tape drives and a tape manager. The system is configured to enable a user to create a stacked tape, unstack a previously stacked tape, and/or consolidate a previously stacked tape. When a stack is created, data is copied from one or more input tapes to an output tape in any desired format using American National Standards Institute (ANSI) standard labeling conventions. When a user requests that data be unstacked, virtual tape volume (VTVs) on one or more input tapes are located and copied to respective opened output tapes. When data is consolidated, VTVs on one or more input tapes are copied to a single output tape. When data consolidation or stack creation is complete, a directory is written to the output tape.

### BRIEF DESCRIPTION OF THE DRAWING(S)

FIG. 1 is a block diagram of a conventional computer system wherein tapes previously written to by a first type of tape drive are not accessible by a second type of tape drive.

FIG. 2A is a block diagram of a computer system wherein tapes previously written by various types of tape drives are accessible to another tape drive wherein the other tape drive may be different from all or all but one of the various types of tape drives.

FIG. 2B is a block diagram of a tape media migration and consolidation manager (TMCM) implemented in an operating system (OS).

FIG. 3 is a flow chart of a method for creating a stacked tape.

FIG. 4 is a flow chart of a method for unstacking a stacked tape.

FIG. 5 is a flow chart of a method for consolidating previously stacked tapes onto a single tape.

FIG. 6 is a diagram of a stacked tape with data organized in accordance with the present invention.

FIG. 7 is a diagram of three input tapes prior to being stacked onto a single output tape.

FIG. 8 is a diagram of a stacked output tape wherein data from the three input tapes of FIG. 7 have been copied to the stacked output tape.

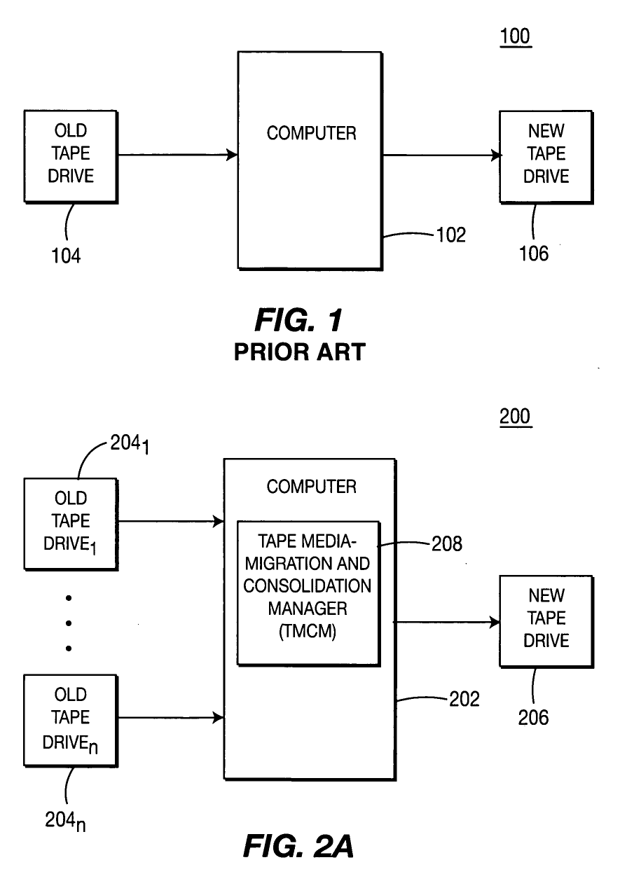

### DETAILED DESCRIPTION OF THE PREFERRED EMBODIMENT(S)

It is noted that the terms old tape drive and new tape drive as used herein do not necessarily mean an obsolete drive versus a newer drive. For example, where two newer tape drives are present and a user simply has a preference for one over the other, the old tape drive simply refers to a drive previously used to write data which the user now wants to access using another tape drive (i.e. the new tape drive). Further, the terms media, tape(s), and cartridge(s) may be used interchangeably herein to refer to the device on which a tape drive writes data.

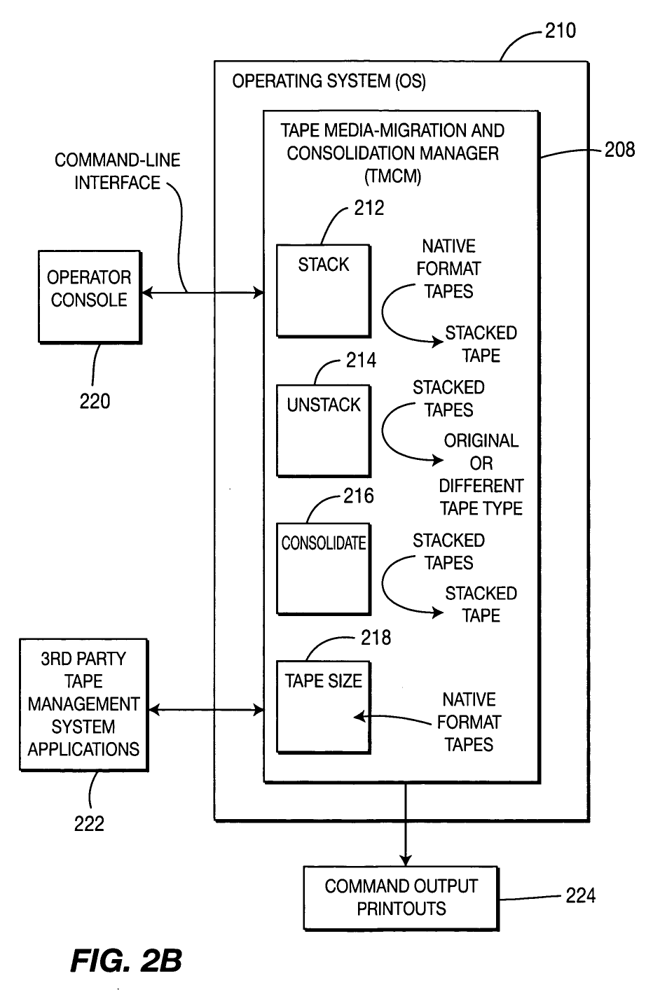

Referring now to FIG. 2A, there is shown a computer system 200 in accordance with the present invention. The system 200 includes a computer 202, a new tape drive 206, and a tape media-migration and consolidation manager (TMCM) 208. Additionally, the computer system may include any number of old tape drives 204 (i.e., 204₁ . . . 204ₙ). The TMCM 208 is configured to enable tapes written by any of the old tape drives 204 to be accessed by the new tape drive 206 in the following way. In a preferred embodiment, the TMCM 208 is configured to enable tapes written by one or more of the old tape drives 204 to be stacked onto a single tape written by the new tape drive 206. The TMCM 208 may also unstack a stacked tape and consolidate previously stacked tapes onto a single tape.

Referring now to FIG. 2B, the TMCM 208 is preferably implemented as a utility in an operating system (OS) 210. In a preferred embodiment, the OS is a proprietary OS such as, for example, Master Control Program (MCP) by Unisys. The TMCM 208 includes a stacking function 212 for stacking any number of tapes in various native formats onto a single tape. As mentioned above, the TMCM 208 also includes an unstacking function 214 and consolidation function 216. Additionally, in an alternate embodiment, the TMCM 208 may include a tape sizing function 218 wherein the amount of data on cartridges eligible for stacking is identified.

In a preferred embodiment, the TMCM 208 is controlled and/or monitored by either an operator console 220 or a third party tape management system 222. It is noted that either of these controllers may direct command outputs to a display screen, a disk file or printer backup file (not shown). Command output is the display results and status of a command entered by the user, such as a directory listing, and this can be sent to the screen, disk file or printer backup file.

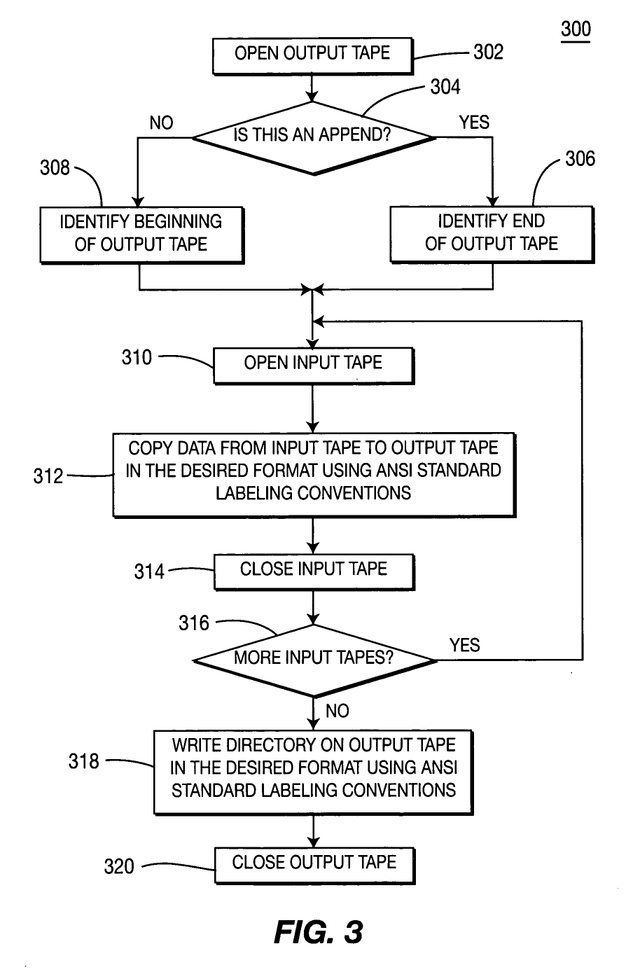

Referring now to FIG. 3, there is shown a flow chart of a method 300 for creating a stacked tape. In this embodiment, data from one or more tapes is input to a computer 202 wherein TMCM 208 outputs the data and stacks it onto a stacked tape. The tape(s) from which the data is provided is referred to as an input tape and the tape on which the data is stacked is referred to as an output tape. The method 300 begins with step 302 with opening the output tape. Then, in step 304, it is determined whether the current operation is an append to data already written to the output tape or not. If it is an append, the end of the output tape is identified in step 306. If the operation is not an append, the beginning of the output tape is identified in step 308.

Once the appropriate point at which to write data to the output tape is identified in either step 306 or 308, the input tape is opened in step 310. Then, in step 312, data is copied from the input tape to the output tape. Once the data is copied to the output tape, the output tape is closed in step 314. The data is preferably copied in any desired format using ANSI standard labeling conventions. In step 316, it is determined whether there are more input tapes. If there are more input tapes, the method 300 returns to step 310. If there are no more input tapes, the method 300 proceeds to step 318.

In step 318, a directory is written on the output tape. The directory is preferably written in any desired format using ANSI standard labeling conventions. As known to those skilled in the art, the directory provides organizational information regarding the data located on the output tape. Once the directory is written, the output tape is closed in step 320 and the method 300 ends.

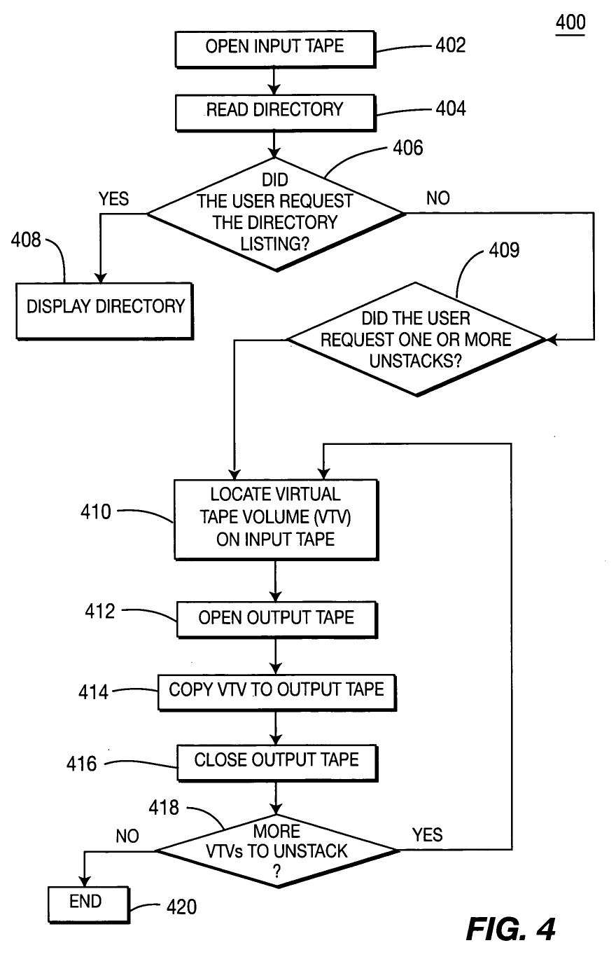

Referring now to FIG. 4, there is shown a flow chart of a method 400 for unstacking a previously stacked tape. In this embodiment, data from one or more previously stacked tapes is input to a computer 202 wherein TMCM 208 unstacks the data and outputs it to another tape. The previously stacked tapes are referred to as input tapes and the other tape(s) is referred to as an output tape(s). The method 400 begins in step 402 with opening the input tape. Once the input tape is open, the directory of the input tape is read. If, in step 406, the user requested the directory listing, the directory is displayed in step 408 and the method 400 ends. If the user requested one or more unstacks in step 409, the method 400 proceeds to step 410. It is noted that when a tape is stacked, the data is preferably organized on the stacked tape in virtual tape volumes (VTVs) wherein each VTV corresponds to data copied from a particular tape.

In step 410, a VTV is located on the input tape. In step 412, an output tape is opened and the VTV located in step 410 is copied to the output tape in step 414. Then, once the VTV is copied to the output tape, the output tape is closed in step 416. if the user has not requested more unstacks in step 418, the method 400 ends in step 420. If there are additional VTVs to unstack, the method 400 returns to step 410 and proceeds as explained above.

It is noted that the stacking/unstacking functions of the present invention are enabled to allow input of heterogeneous media types (e.g. 18-track, 36-track, 9840) into a single stacked tape wherein data copied to the stacked tape is available in a single format on the stacked tape. In a preferred embodiment, retrieval of a VTV from a stacked tape will automatically perform any necessary translations between media types to convert the volume into a format consistent with the output tape type thereby enabling media translation across various formats.

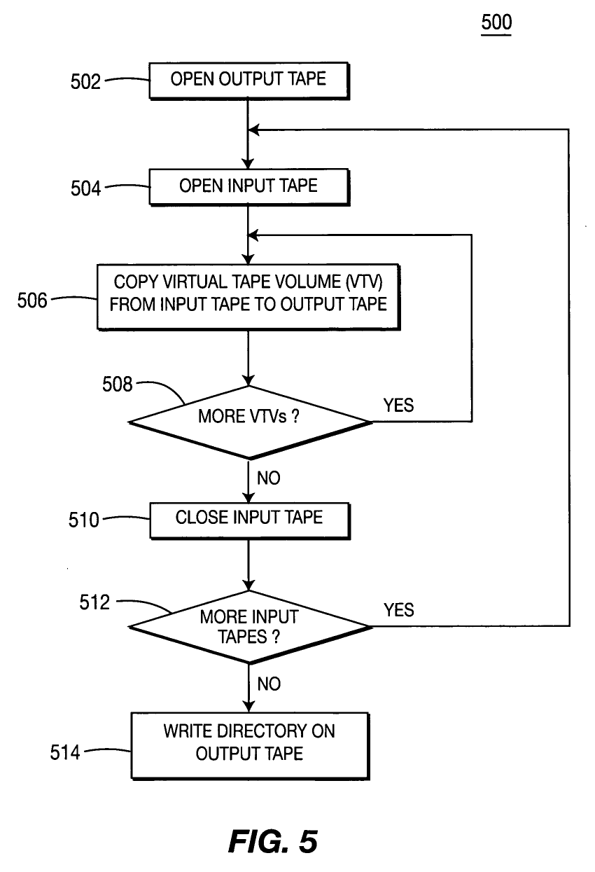

Referring now to FIG. 5, there is shown a flow chart of a method 500 for consolidating stacked tapes on a single tape. In this embodiment, VTVs from previously stacked tapes are input to a computer 202 and TMCM 208 outputs the VTVs to a single tape. The previously stacked tapes are referred to as input tapes and the single tape on which the VTVs are consolidated is referred to as an output tape. The method 500 begins in step 502 with opening an output tape. Next, in step 504, an input tape is opened. Then, in step 506, a VTV from the input tape is copied by the TMCM 208 to the output tape.

In step 508, it is determined whether there are more VTVs on the input tape. If there are more VTVs, the method 500 returns to step 506. If there are no more VTVs, the method 500 proceeds to step 510 where the output tape is closed. In step 512, it is determined whether there are more input tapes. If there are more input tapes, the method 500 returns to step 504. If there are no more input tapes, the TMCM 208 writes a directory on the output tape in step 514 and the method 500 ends.

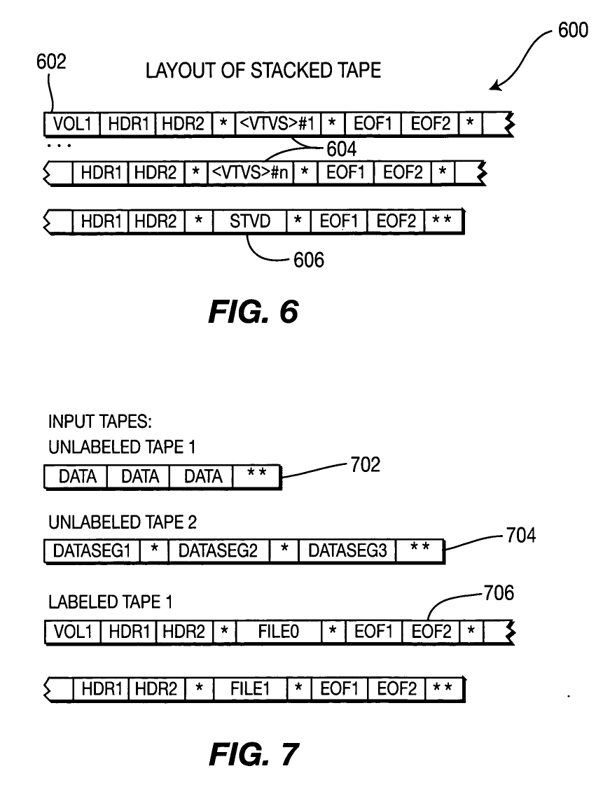

In a preferred embodiment, the TMCM 208 is implemented as a utility in a proprietary OS. For example, a preferred implementation of the present invention is to include TMCM 208 as a utility of Unisys' MCP OS. To illustrate an example of implementing TMCM 208 in MCP, reference is made is to FIG. 6. It is noted that where TMCM 208 is implemented as a utility to MCP, TMCM 208 is referred to as Giza or the Giza utility.

In FIG. 6, a basic layout of a Giza stacked tape 600 is shown. The layout shown in FIG. 6 is the layout of an output tape in a stacking operation and the layout of an input tape in an unstacking operation. Data copied from other tapes is included on the tape 600 in the form of virtual tape volume segments (VTVSs) 604. A VTVS is a direct byte-for-byte copy of a tape file from the original physical tape from which the data was copied. The VTVSs are preferably marked to delineate the beginning and end of any VTVS. Labels created for Giza are preferably standard ANSI69 labels created by MCP when using a standard label tape convention. Standard labels created for Giza include VOL1, HDR1, HDR2, EOF1, and EOF2. HDR1 and HDR2 are used to delineate the beginning of a VTVS and EOF1 and EOF2 are used to delineate the end of a VTVS.

A stacked tape volume directory (STVD) 606 is preferably the last file on a stacked tape 600. The STVD 606 preferably includes information about the number of VTVs included in the stacked tape 600 and information about each VTV.

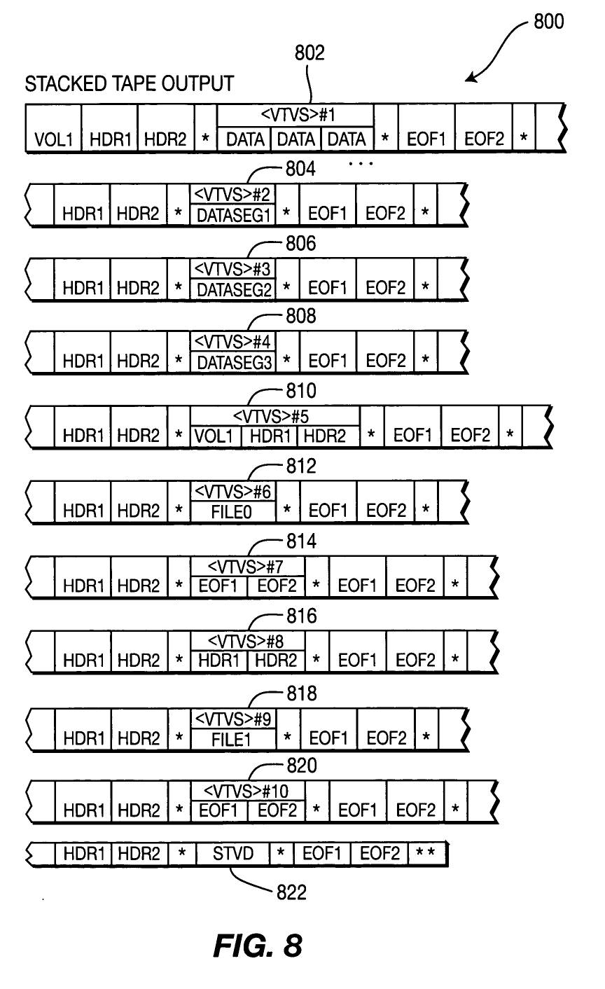

To provide an example of a stacking operation in accordance with a preferred embodiment of the present invention, reference is made to FIGS. 7 and 8. In FIG. 7, there are three input tapes 702, 704, 706 that will be stacked onto a single output tape. The first input tape 702 is an unlabeled tape having three records of data. The second tape 704 is an unlabelled tape with three records of data separated by tape marks *. The third tape is a labeled tape having standard headers (HDR1, HDR2, EOF1, EOF2) a directory, and a file (File1).

The input tapes 702, 704, 706 are preferably stacked onto an output tape 800 as shown in FIG. 8. The data on tape 702 may be grouped into a single VTVS 802 because there are no tape marks separating the three data records. The data on tape 704 is preferably written using three VTVSs 804, 806, 808, because there are three sections separated by tape marks. The data on tape 706 is preferably written using six VTVSs 810, 812, 814, 816, 818, 820, because there are six sections separated by tape marks. As explained above, a STVD 822 is also included on the stacked output tape 800.

Purely by way of example, a sample format for an STVD is shown below. As noted above, however, the STVD may be in any format as desired.

| Offset | Field Name | Type | Size | Contents |
|---|---|---|---|---|
| 0 | STVD ID | Extended Binary | 3 | “USF” |
| | | Coded Decimal | | |
| | | Interchange Code | | |
| | | (EBCDIC) chars | | |
| 3 | Version | EBCDIC digits | 3 | Version. Initial version is “001”. |
| 6 | Valid VTV Count | EBCDIC digits | 3 | Number of valid VTVs in the |
| | | | | STVD. |

The following group of fields are repeated for each VTV:

| | | | | |
|---|---|---|---|---|
| 0 | VTV Volser | EBCDIC chars | 6 | Virtual tape volume serial number |
| | | | | (in EBCDIC). |
| 6 | VTV Segment ID | EBCDIC digits | 6 | ID of the first VTVS of the VTV |
| | | | | on the stacked tape. |
| 12 | VTV Segment | EBCDIC digits | 6 | Number of (consecutive) VTVSs |
| | Count | | | that make up the VTV. |
| 18 | VTV Block ID | EBCDIC digits | 12 | Block ID of the first VTVS of the |
| | | | | VTV on the stacked tape. The |
| | | | | block ID corresponds to what |
| | | | | would be passed to the tape drive |
| | | | | on a position command. |
| 30 | VTV Created | EBCDIC chars | 8 | Date the VTV was created on the |
| | Date | | | stacked tape. Format is |
| | | | | “YYYYMMDD”. |
| 38 | VTV Created | EBCDIC chars | 6 | Time that the VTV was created on |
| | Time | | | the stacked tape (relative to the |
| | | | | VTV Creation Date). Format is |
| | | | | “HHMMSS”. |
| 44 | VTV Timestamp | Real | 6 | Timestamp in Real format |
| 50 | VTV Size | EBCDIC digits | 6 | Size of VTV |
| 56 | VTV Created | EBCDIC digits | 6 | Drive type of original VTV |
| | Drive | | | |
| 62 | VTV Status | EBCDIC chars | 2 | Reserved for status of the VTV. |
| | | | | Initially set to valid. |
| | | | | “VA” - means the VTV is valid. |
| | | | | “IV” - means the VTV has been set |
| | | | | to invalid. |
| 64 | Comment | EBCDIC chars | 20 | Comment |

It is noted that the present invention may be implemented in a variety of systems and that the various techniques described herein may be implemented in hardware or software, or a combination of both. Furthermore, while the present invention has been described in terms of various embodiments, other variations, which are within the scope of the invention as outlined in the claims below will be apparent to those skilled in the art.

What is claimed is:

1. A system for managing the transfer of data from one tape to another, the system comprising:
(a) a plurality of tape drives; and
(b) a tape manager in communication with the tape drives, the tape manager comprising:
(b1) means for stacking any number of input tapes formatted in various formats onto a single output tape;
(b2) means for unstacking at least one stacked tape; and
(b3) means for consolidating at least one previously stacked tape.

2. The system of claim 1 wherein an output tape on which data is to be stacked is opened and an appropriate location on the opened output tape to begin to write data is identified.

3. The system of claim 2 wherein the appropriate location on the opened output tape is at the beginning of the output tape.

4. The system of claim 2 wherein the appropriate location on the opened output tape is at the end of data already existing on the opened tape.

5. The system of claim 2 wherein at least one input tape from which data is to be copied from is opened, and the data is copied to the appropriate location on the opened output tape in any desired format using American National Standards Institute (ANSI) standard labeling conventions.

6. The system of claim 5 wherein a directory is written to the output tape in a predetermined format, and the output tape is closed after data from the at least one input tape is copied.

7. The system of claim 1 further comprising:
(c) a display screen in communication with the tape manager, wherein at least one input tape from which data is to be read is opened, and if a user requests a directory listing, the directory is read and presented on the display screen.

8. The system of claim 1 wherein at least one input tape from which data is to be read is opened, the input tape including at least one virtual tape volume (VTV), and if the input tape includes a user request that data be unstacked, a VTV is located on the input tape, an output tape is opened, the located VTV is copied to the opened output tape, and the output tape is closed.

9. The system of claim 1 wherein an input tape and an output tape are opened, the input tape including at least one virtual tape volume (VTV), the at least one VTV is copied by the tape manager to the output tape, and the tape manager writes a directory on the output tape.

10. The system of claim 1 wherein the tape manager further comprises:
(b4) means for identifying the amount of data on input tapes eligible for stacking.

11. The system of claim 1 wherein the tape drives include at least one of an 18-track tape drive, a 36-track tape drive, and a 9840 tape drive.

12. A method for managing the transfer of data from one tape to another, the method comprising:
(a) stacking any number of input tapes formatted in various formats onto a single output tape;
(b) unstacking at least one stacked tape; and
(c) consolidating at least one previously stacked tape.

13. The method of claim 12 wherein step (a) comprises:
(a1) opening an output tape on which data is to be stacked; and
(a2) identifying an appropriate location on the opened output tape to begin to write data.

14. The method of claim 13 wherein the appropriate location on the opened output tape is at the beginning of the output tape.

15. The method of claim 13 wherein the appropriate location on the opened output tape is at the end of data already existing on the opened tape.

16. The method of claim 13 wherein step (a) further comprises:
(a3) opening at least one input tape from which data is to be copied; and
(a4) copying the data to the appropriate location on the opened output tape in any desired format using American National Standards Institute (ANSI) standard labeling conventions.

17. The method of claim 16 wherein steps (a3) and (a4) are repeated for each of a plurality of VTVs located on the input tape.

18. The method of claim 16 wherein step (a) further comprises:
(a5) writing a directory to the output tape in a predetermined format; and
(a6) closing the output tape after data from the at least one input tape is copied.

19. The method of claim 12 wherein step (b) further comprises:
(b1) opening at least one input tape; and
(b2) reading and displaying a directory on the input tape when the input tape does not include data to be processed.

20. The method of claim 12 wherein step (b) further comprises:
(b1) opening an input tape;
(b2) receiving a request for data to be unstacked;
(b3) locating a first virtual tape volume (VTV) on the input tape;
(b4) opening a first output tape;
(b5) copying the located VTV to the opened first output tape;
(b6) closing the first output tape;
(b7) locating a second VTV on the input tape;
(b8) opening a second output tape;
(b9) copying the second located VTV to the opened second output tape; and
(b10) closing the second output tape.

21. The method of claim 12 wherein step (c) further comprises:
(c1) opening an output tape;
(c2) opening an input tape;
(c3) locating a virtual tape volume (VTV) on the input tape;
(c4) copying the located VTV to the opened output tape; and
(c5) writing a directory on the output tape.

22. The method of claim 21 wherein steps (c3) and (c4) are repeated for each of a plurality of VTVs located on the input tape.

23. The method of claim 21 wherein steps (c2)-(c4) are repeated for each of a plurality of input tapes.

24. The method of claim 12 further comprising:
(d) identifying the amount of data on input tapes eligible for stacking.

25. The method of claim 12 wherein the various formats include at least one of 18-track, 36-track, and 9840.
